(19) United States
(12) Patent Application Publication
(10) Pub. No.: US 2021/0293613 A1
(43) Pub. Date: Sep. 23, 2021

(54) DIAGNOSTIC APPARATUS AND DIAGNOSTIC METHOD

(71) Applicant: Ricoh Company, Ltd., Tokyo (JP)

(72) Inventor: Yuko KITANO, Kanagawa (JP)

(73) Assignee: Ricoh Company, Ltd., Toky (JP)

(21) Appl. No.: 17/182,345

(22) Filed: Feb. 23, 2021

(30) Foreign Application Priority Data
Mar. 18, 2020 (JP) 2020-048488

(51) Int. Cl. G01H 17/00; G01M 13/00

(52) U.S. Cl. CPC G01H 17/00; G01M 13/00

(57) ABSTRACT

A diagnostic apparatus for diagnosing a state of a pressing machine includes circuitry configured to generate a spectrogram based on a vibration waveform indicating changes with elapse of time in a vibration of the pressing machine configured to perform a pressing process in which a tool is pressed against a material to deform the material. The circuitry determines an abnormality type of the pressing machine based on a characteristic of the spectrogram corresponding to the vibration of the pressing machine generated at a predetermined timing during the pressing process.

### CROSS-REFERENCE TO RELATED APPLICATIONS

This patent application is based on and claims priority pursuant to 35 U.S.C. 119(a) to Japanese Patent Application No. 2020-048488, filed on Mar. 18, 2020, in the Japan Patent Office, the entire disclosure of which is hereby incorporated by reference herein.

### BACKGROUND

### Technical Field

The present disclosure relates to a diagnostic apparatus and a diagnostic method.

### Related Art

There is a technology for detecting abnormalities in a pressing machine that performs pressing process, that is, presses a tool against a material to deform the material.

Various types of abnormalities can occur in the pressing machine.

### SUMMARY

An embodiment of the present disclosure provides a diagnostic apparatus for diagnosing a state of a pressing machine configured to perform a pressing process in which a tool is pressed against a material to deform the material. The diagnostic apparatus includes circuitry configured to generate a spectrogram based on a vibration waveform indicating changes with elapse of time in a vibration of the pressing machine. The circuitry determines an abnormality type of the pressing machine based on a characteristic of the spectrogram corresponding to the vibration of the pressing machine generated at a predetermined timing during the pressing process.

Another embodiment provides a diagnostic apparatus for diagnosing a state of a pressing machine configured to perform a pressing process in which a tool is pressed against a material to deform the material. The diagnostic apparatus includes circuitry configured to generate a spectrogram based on a vibration waveform indicating changes with elapse of time in a vibration of the pressing machine, and visualize the spectrogram corresponding to the vibration of the pressing machine generated at a predetermined timing during the pressing process.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a view illustrating an example of a system configuration of a press working system according to an embodiment of the present disclosure;

FIG. 2 is a block diagram illustrating an example of a hardware configuration of a pressing machine of the press working system illustrated in FIG. 1;

FIG. 3 is a block diagram illustrating an example of a hardware configuration of a diagnostic apparatus of the press working system illustrated in FIG. 1;

FIG. 4 is a block diagram illustrating an example of a functional configuration of the diagnostic apparatus illustrated in FIG. 3;

FIG. 5 is a graph illustrating examples of a predetermined timing during a pressing process in the press working system illustrated in FIG. 1;

FIG. 6 is a graph illustrating an example of a reference vibration;

FIG. 7 is a graph illustrating an example of a reference;

FIG. 8 is a graph illustrating an example of a vibration waveform at the time of abnormality;

FIG. 9 is a graph illustrating an example of a spectrogram at the time of abnormality;

FIG. 10 is a flowchart illustrating an example of an overall diagnosis operation performed by the diagnostic apparatus illustrated in FIG. 4;

FIG. 11 is a flowchart illustrating an example of an operation of reference data acquisition performed by the diagnostic apparatus illustrated in FIG. 4;

FIG. 12 is a flowchart illustrating an example of an operation of abnormality determination performed by the diagnostic apparatus illustrated in FIG. 4; and

FIG. 13 is a block diagram illustrating an example of a functional configuration of a diagnostic apparatus according to a modified example.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, embodiments of a diagnostic apparatus, a diagnostic method, and a diagnostic program according to the present disclosure are described in detail with reference to the drawings.

System Configuration of Press Working System

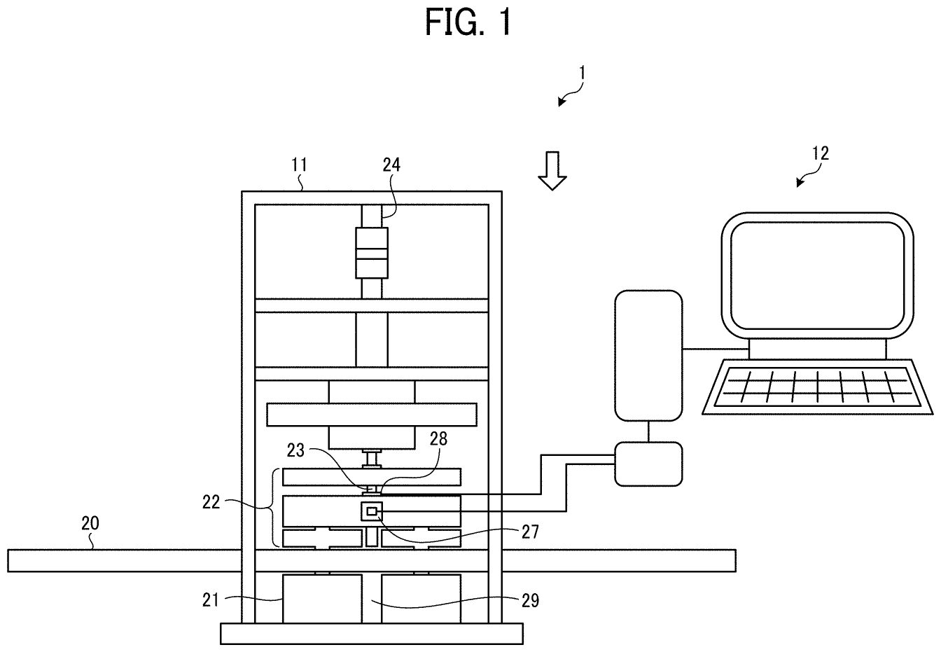

FIG. 1 is a diagram illustrating an example of a system configuration of a press working system 1 according to the present embodiment. The press working system 1 includes a pressing machine 11 and a diagnostic apparatus 12.

The pressing machine 11 is a machine that performs pressing process, that is, presses a tool against a material 20, such as a metal plate, to deform the material 20. The pressing machine 11 includes a lower die 21, an upper die 22, a punching tool 23, a motor 24, an accelerometer 27, and a load sensor 28.

The material 20 is secured between the lower die 21 and the upper die 22. The punching tool 23 is moved in the vertical direction in the drawing, driven by the motor 24. The pressing machine 11 according to the present embodiment performs shearing. Specifically, the punching tool 23 descends to penetrate the material 20 and enter a hole 29 in the lower die 21, thereby forming a hole in the material 20.

The accelerometer 27 is a sensor that detects vibrations of the pressing machine 11 (including vibrations of the material 20). The accelerometer 27 according to the present embodiment is disposed on a part of the upper die 22, but the position is not limited thereto. The accelerometer 27 may be disposed at any position as long as the accelerometer 27 can detect vibrations of the pressing machine 11 or vibrations of the material 20 generated during the pressing process. For example, the accelerometer 27 may be disposed on the upper die 22.

The load sensor 28 is a sensor that detects a load (elastic wave) applied to the punching tool 23. The load sensor 28 according to the present embodiment is integral with the punching tool 23, but the configuration is not limited thereto.

The pressing machine 11 illustrated in FIG. 1 performs a shearing process as a pressing process, but the pressing machine 11 may be configured to perform a different operation. For example, the pressing machine 11 may include exchangeable tools and have a capability of pressing process other than shearing with another tool.

The diagnostic apparatus 12 diagnoses the state of the pressing machine 11. The diagnostic apparatus 12 according to the present embodiment determines the presence or absence of abnormality and the type of abnormality of the pressing machine 11 based on the detection signal (vibration information) from the accelerometer 27, the detection signal (load information) from the load sensor 28, and the like.

Hardware Configuration of Pressing Machine

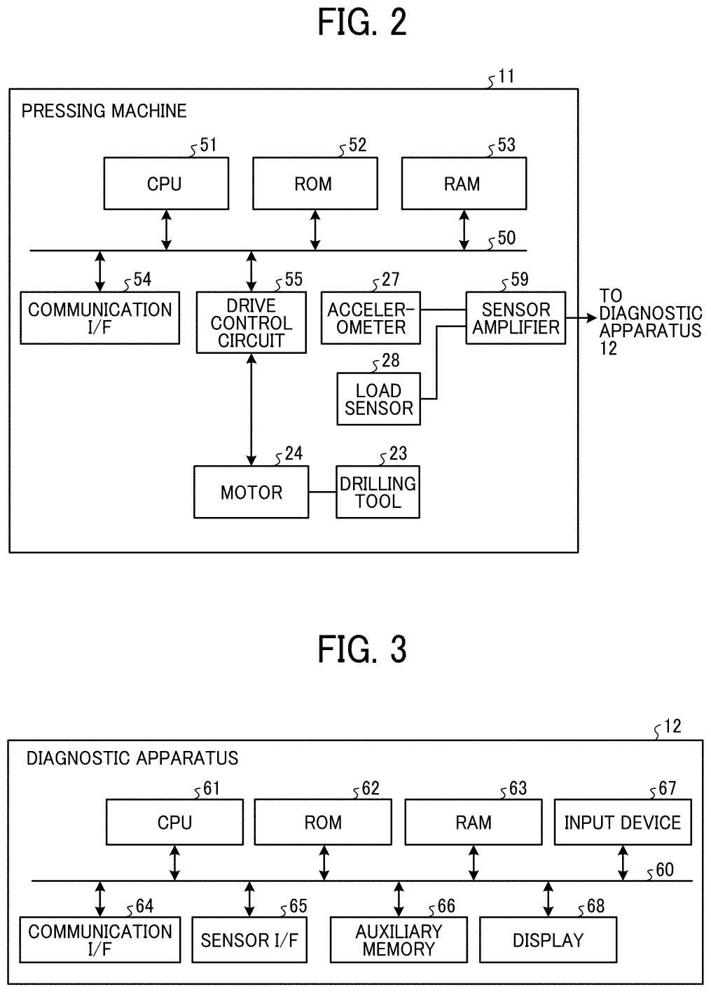

FIG. 2 is a block diagram illustrating an example of a hardware configuration of the pressing machine 11 according to the present embodiment.

The pressing machine 11 includes a central processing unit (CPU) 51, a read only memory (ROM) 52, a random access memory (RAM) 53, a communication interface (I/F) 54, and a drive control circuit 55, which are connected via a bus 50 to communicate with each other.

The CPU 51 is a processor that controls the entire operation of the pressing machine 11. For example, the CPU 51 executes a control program stored in the ROM 52 or the like using the RAM 53 as a work area, to control the entire operation of the pressing machine 11, to execute pressing process.

The communication I/F 54 is an interface for communication with an external device such as the diagnostic apparatus 12. The communication I/F 54 is, for example, a network interface card (NIC) in compliance with transmission control protocol/internet protocol (TCP/IP).

The drive control circuit 55 is a circuit that controls the motor 24 that moves the punching tool 23 used for pressing process. The drive control circuit 55 is driven in response to an instruction signal or the like from the CPU 51.

The pressing machine 11 further includes a sensor amplifier 59 to which the accelerometer 27 and the load sensor 28 are connected. The sensor amplifier 59 is connected to the diagnostic apparatus 12 to communicate therewith. The accelerometer 27, the load sensor 28, and the sensor amplifier 59 may be built-in components of the pressing machine 11, or may be attached to the assembled pressing machine 11. The sensor amplifier 59 is not necessarily mounted in the pressing machine 11, but may be mounted in the diagnostic apparatus 12.

The hardware configuration illustrated in FIG. 2 is an example, and the pressing machine 11 does not necessarily include all of the above components, and may include other components.

Hardware Configuration of Diagnostic Apparatus

FIG. 3 is a block diagram illustrating an example of a hardware configuration of the diagnostic apparatus 12 according to the present embodiment.

The diagnostic apparatus 12 includes a CPU 61, a ROM 62, a RAM 63, a communication IN 64, a sensor I/F 65, an auxiliary memory 66, an input device 67, and a display 68, which are connected via a bus 60 to communicate with each other.

The CPU 61 is a processor that controls the entire operation of the diagnostic apparatus 12. For example, the CPU 61 controls the entire operation of the diagnostic apparatus 12 by executing a program such as a diagnostic program stored in the ROM 62 or the like using the RAM 63 as a work area, to implement a diagnostic function.

The communication I/F 64 is an interface for communication with an external device such as the pressing machine 11. The communication I/F 64 is, for example, an NIC or the like in compliance with TCP/IP.

The sensor I/F 65 is an interface that receives detection signals (vibration information and load information) from the accelerometer 27 and the load sensor 28 installed in the pressing machine 11 via the sensor amplifier 59.

The auxiliary memory 66 is a non-volatile memory such as a hard disk drive (HDD), a solid state drive (SSD), and an electrically erasable programmable read-only memory (EEPROM). The auxiliary memory 66 stores various data such as setting information of the diagnostic apparatus 12, detection signals received from the pressing machine 11, context information, an operating system (OS), and an application program.

The auxiliary memory 66 is included in the diagnostic apparatus 12 in an embodiment, but the location is not limited thereto. The auxiliary memory 66 may be, for example, a memory installed outside the diagnostic apparatus 12, a memory in a cloud server capable of data communication with the diagnostic apparatus 12, and the like.

The input device 67 is a device such as a mouse or keyboard for performing input of characters and numbers, designating various instructions, and moving a cursor.

The display 68 is, for example, a cathode ray tube (CRT) display, a liquid crystal display (LCD), or an organic electro luminescence (EL) display that displays characters, numbers, various screens, operation icons, and the like.

The hardware configuration illustrated in FIG. 3 is an example, and the diagnostic apparatus 12 does not necessarily include all of the above components, and may include another component.

Functional Configuration of Diagnostic Apparatus

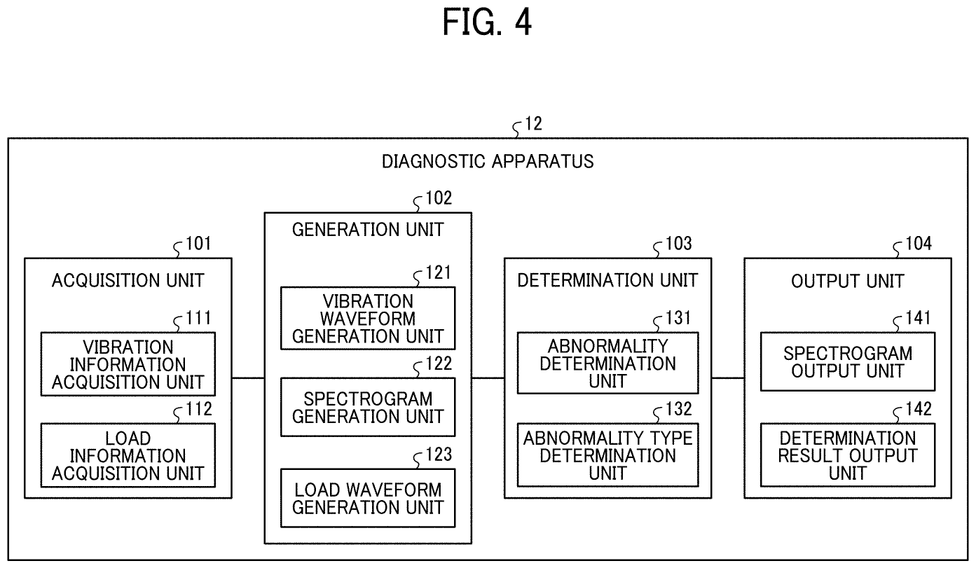

FIG. 4 is a block diagram illustrating an example of a functional configuration of the diagnostic apparatus 12 according to the present embodiment. The diagnostic apparatus 12 includes an acquisition unit 101, a generation unit 102, a determination unit 103, and an output unit 104. The functional units described below are implemented by the cooperation between the hardware components (the bus 60 to the display 68) of the diagnostic apparatus 12 illustrated in FIG. 3 and a program (diagnostic program or the like) stored in the ROM 62 or the auxiliary memory 66.

The acquisition unit 101 acquires various information transmitted from the pressing machine 11. The acquisition unit 101 according to the present embodiment includes a vibration information acquisition unit 111 and a load information acquisition unit 112.

The vibration information acquisition unit 111 acquires the detection signal (vibration information) of the accelerometer 27. The load information acquisition unit 112 acquires the detection signal (load information) of the load sensor 28.

The generation unit 102 generates information for determining an abnormality of the pressing machine 11 based on the information acquired by the acquisition unit 101. The generation unit 102 according to the present embodiment includes a vibration waveform generation unit 121, a spectrogram generation unit 122, and a load waveform generation unit 123.

Based on the vibration information acquired by the vibration information acquisition unit 111, the vibration waveform generation unit 121 generates a vibration waveform that indicates changes with elapse of time in the vibration of the pressing machine 11 during pressing process.

The spectrogram generation unit 122 generates a spectrogram based on the vibration waveform generated by the vibration waveform generation unit 121.

Based on the load information acquired by the load information acquisition unit 112, the load waveform generation unit 123 generates a load waveform that indicates changes with elapse of time in the load applied to the punching tool 23 during pressing process.

The determination unit 103 determines an abnormality in the pressing machine 11 based on the information generated by the generation unit 102. The determination unit 103 according to the present embodiment includes an abnormality determination unit 131 and an abnormality type determination unit 132.

The abnormality determination unit 131 determines the presence or absence of an abnormality in the pressing machine 11 based on the vibration waveform generated by the vibration waveform generation unit 121. The abnormality determination unit 131 determines the presence or absence of an abnormality based on, for example, a comparison result of a preliminarily prepared vibration waveform in normal operation and a vibration waveform acquired during pressing process.

The abnormality type determination unit 132 determines the type of abnormality in the pressing machine 11 based on the spectrogram generated by the spectrogram generation unit 122. The abnormality type determination unit 132 determines (identifies) the type of abnormality based on the characteristics of the spectrogram corresponding to the vibration of the pressing machine 11 generated at a predetermined timing during the pressing process.

The type of abnormality includes, for example, a defect of a tool and a forming defect of the material 20. The defect of the tool is, for example, wear of the punching tool 23. The forming defect is, for example, a defect in the shape of the through hole of the material 20 formed in the shearing process. The predetermined timing is, for example, a time at which the punching tool 23 comes into contact with the material 20 during the shearing, or a time at which the punching tool 23 has penetrated the material 20. The time of contact and the time of penetration can be identified based on the load waveform generated by the load waveform generation unit 123. The type of abnormality and the predetermined timing are not limited to the above, and determined according to the type of pressing process to be performed, the type of the tool used, the type of the material 20, and the like.

The output unit 104 outputs the determination result by the determination unit 103. The output unit 104 according to the present embodiment includes a spectrogram output unit 141 and a determination result output unit 142.

The spectrogram output unit 141 outputs the spectrogram generated by the spectrogram generation unit 122. The spectrogram output unit 141 visualizes a spectrogram corresponding to a time zone including the predetermined timing (for example, the time of contact and the time of penetration) during execution of pressing process.

The determination result output unit 142 outputs information indicating at least one of the presence or absence of an abnormality determined by the abnormality determination unit 131 and information indicating the type of abnormality determined by the abnormality type determination unit 132.

The functional configuration illustrated in FIG. 4 is an example, and the diagnostic apparatus 12 does not necessarily include all of the above components, and may include other components. For example, the output unit 104 may further include, in addition to the spectrogram output unit 141 and the determination result output unit 142, functional units configured to output a vibration waveform and a load waveform.

A description is given below of examples of the predetermined timing.

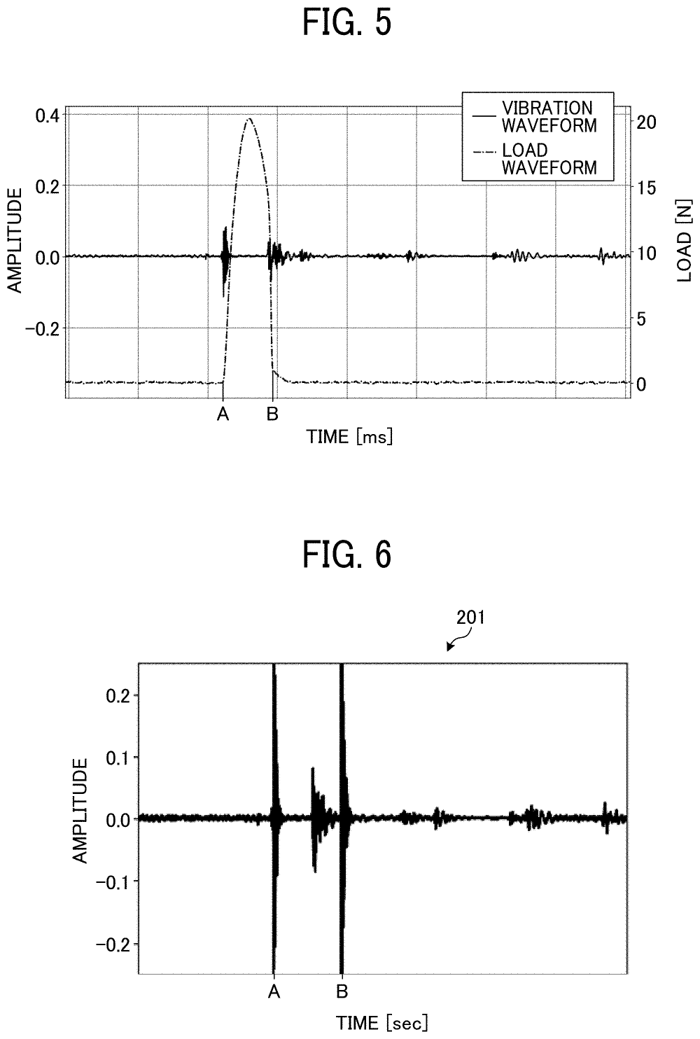

FIG. 5 is a graph illustrating examples of the predetermined timing during execution of the pressing process according to the present embodiment. FIG. 5 illustrates a vibration waveform and a load waveform during the execution of shearing, and a contact time A and a penetration time B as examples of the predetermined timing.

In FIG. 5, the load waveform sharply rises at the contact time A, at which the punching tool 23 contacts the material 20, and sharply drops at the penetration time B, at which the punching tool 23 has penetrated the material 20. Further, in FIG. 5, the amplitude of the vibration waveform increases at the contact time A and the penetration time B. In this way, the diagnostic apparatus 12 can identify the contact time A and the penetration time B, which are the timings at which characteristic vibrations are likely to occur with reference to the load waveform.

Abnormality Determination

A description is given below of determination of an abnormality (wear of the punching tool 23) occurring during the execution of shearing, with reference to FIGS. 6 to 9.

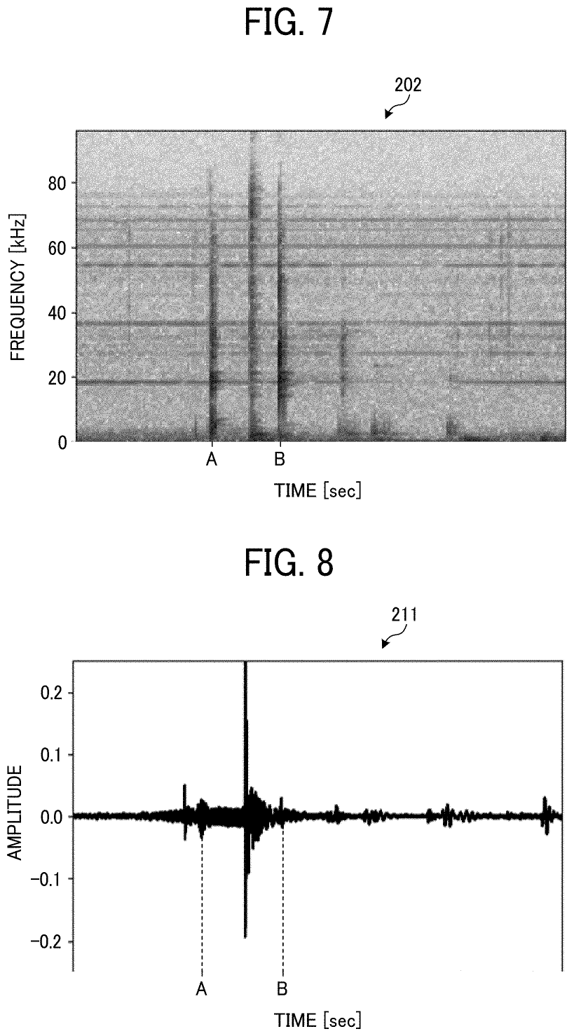

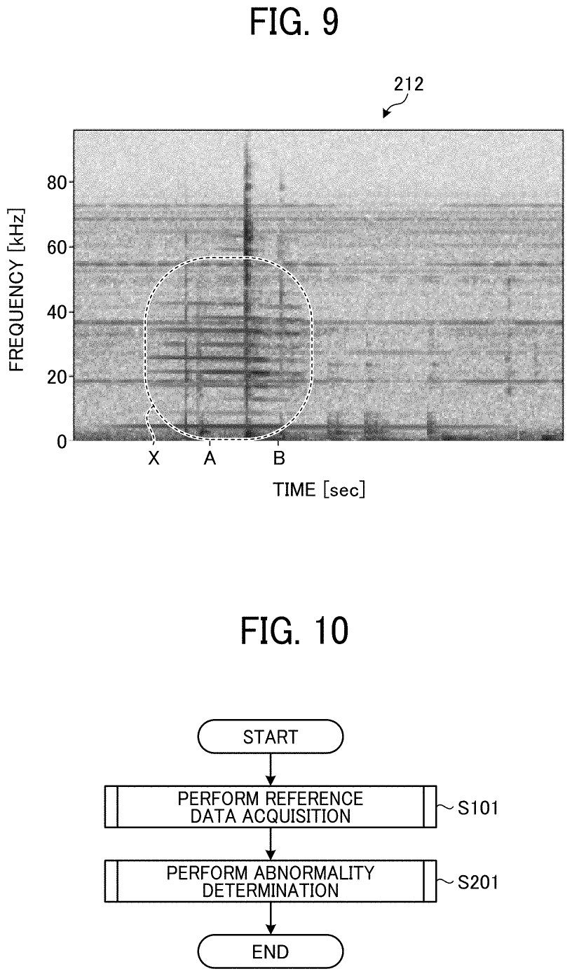

FIG. 6 is a graph illustrating an example of a reference vibration waveform 201 according to the present embodiment. FIG. 7 is a graph illustrating an example of a reference spectrogram 202 according to the present embodiment. FIG. 8 is a graph illustrating an example of a vibration waveform 211 at the time of abnormality, according to the present embodiment. FIG. 9 is a graph illustrating an example of a spectrogram 212 at the time of abnormality, according to the present embodiment.

The reference vibration waveform 201 illustrated in FIG. 6 is an example of the vibration waveform acquired when shearing is normally performed, and corresponds to a time zone including the above-mentioned contact time A and the penetration time B. The reference spectrogram 202 illustrated in FIG. 7 is an example of the spectrogram based on the reference vibration waveform 201 illustrated in FIG. 6, that is, the spectrogram acquired when shearing is normally performed.

The vibration waveform 211 illustrated in FIG. 8 is an example of a vibration waveform acquired when shearing is performed with the worn punching tool 23, and corresponds to the time zone including the contact time A and the penetration time B. The spectrogram 212 illustrated in FIG. 9 is an example of the spectrogram based on the vibration waveform 211 illustrated in FIG. 8, that is, the spectrogram when shearing is performed with the worn punching tool 23.

A description is given below of determination of the presence or absence of an abnormality.

Comparing the reference vibration waveform 201 illustrated in FIG. 6 with the vibration waveform 211 illustrated in FIG. 8, the amplitudes at the contact time A and the penetration time B are significantly different therebetween. Accordingly, when a difference of a certain degree or more is detected between the reference vibration waveform 201 and the vibration waveform 211 to be diagnosed, it can be determined that an abnormality has occurred during the shearing process. Thus, with the diagnostic apparatus 12, the presence or absence of abnormality in the pressing machine 11 can be determined based on the characteristics of the vibration waveform corresponding to the predetermined timings (the contact time A and the penetration time B) during the shearing process.

A description is given of determination of abnormality type.

As described above, the presence or absence of an abnormality can be determined from the characteristics of the vibration waveform. However, the type of abnormality may not be determined from the characteristics of the vibration waveform. In view of the foregoing, the diagnostic apparatus 12 according to the present embodiment determines the type of abnormality based on the characteristics of the spectrogram.

Comparing the reference spectrogram 202 illustrated in FIG. 7 and the spectrogram 212 illustrated in FIG. 9, the spectrogram 212 to be diagnosed has a characteristic X that is not in the reference spectrogram 202 in the time zone from the contact time A to the penetration time B. The characteristic X is an example of a characteristic corresponding to the vibration peculiar to shearing of the material 20 by the worn punching tool 23. In a color image, the characteristic X is represented by a plurality of lines having a color different from the color of the corresponding portion of the reference spectrogram 202. In this way, characteristics of the spectrogram peculiar to each type of abnormality can be presented in a visually recognizable manner. Conceivably, there is a spectrogram characteristic for each type of abnormality. Therefore, by monitoring whether or not a predetermined characteristic (such as the characteristic X) appears in the spectrogram acquired during the pressing process, it is possible to determine the type of abnormality in real time, in addition to the presence or absence of an abnormality.

The method for determining whether or not a unique characteristic such as the characteristic X appears in the spectrogram 212 to be diagnosed is not particularly limited. For example, image recognition processing or artificial intelligence can be used to determine whether or not the spectrogram has such a characteristic. Alternatively, a user (e.g., an administrator of the pressing machine 11) may determine, for example, by viewing the spectrogram 212 on the display 68.

Although the description above concerns an example in which the punching tool 23 is worn, the types of abnormalities that can be detected by the diagnostic apparatus 12 are not limited thereto. For example, in order to detect a forming defect of the material 20, similarly to the above-described example, whether or not the spectrogram to be diagnosed has a characteristic peculiar to the vibration at the time of the forming defect is determined.

A description is given below of

an example of the diagnostic flow by the diagnostic apparatus 12, with reference to FIGS. 10 to 12.

FIG. 10 is a flowchart illustrating an example of the overall sequence of the diagnosis in the diagnostic apparatus 12 according to the present embodiment. When the pressing process by the pressing machine 11 is started, first, the diagnostic apparatus 12 acquires the reference data (S101), and then determines the presence or absence of abnormality and the type of abnormality using the acquired reference data (S201). The reference data is data acquired when pressing process is normally performed, and is stores in a predetermined memory, such as, the auxiliary memory 66. The reference vibration waveform 201 and the reference spectrogram 202 are examples of the reference data.

Reference Data Acquisition

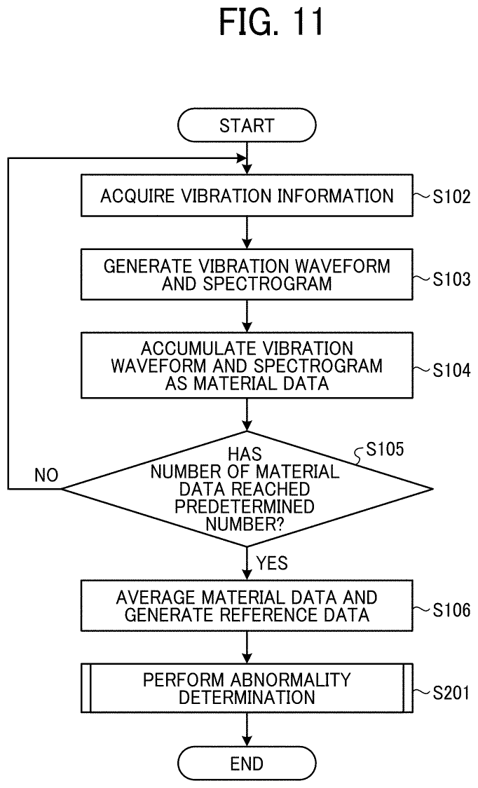

FIG. 11 is a flowchart illustrating an example of a sequence of processes of the reference data acquisition according to the present embodiment. When the pressing process is started, at S102, the vibration information acquisition unit 111 acquires vibration information from the accelerometer 27. At S103, the vibration waveform generation unit 121 generates a vibration waveform based on the vibration information, and the spectrogram generation unit 122 generates a spectrogram based on the vibration waveform. The generated vibration waveform and spectrogram are stored in a predetermined memory as material data for generating reference data (the reference vibration waveform 201 and the reference spectrogram 202) in S104. In S105, the diagnostic apparatus 12 determines whether or not the number of material data has reached a predetermined value (predetermined number). The predetermined value is the number of material data required to generate the reference data, and may be arbitrarily set by the user.

In response to a determination that the number of material data has not yet reached the predetermined value (S105: No), the processes after step S102 are executed again. In response to a determination that the number of material data has reached the predetermined value (S105: Yes), a plurality of accumulated material data are averaged to generate reference data, and the generated reference data is stored (S106). For example, when the predetermined value is 5, the vibration waveform generation unit 121 averages the five vibration waveforms and generates the reference vibration waveform 201, and the spectrogram generation unit 122 generates the reference spectrogram 202 based on the five spectrograms. After that, the abnormality determination is executed in S201.

The reference data acquisition in S101 is executed on the assumption that the pressing process is normally performed up to the predetermined number of times after the pressing process is started. Further, when different pressing processes are executed, after replacing the tool, or changing the type of the material 20 or the shape of the material 20, the reference data acquisition in S101 is executed again to update the reference data. The method of acquiring reference data is not limited to the above-described method. For example, reference data generated based on a preliminarily performed experiment may be stored in a predetermined storage area. Preferably, a spectrogram or the like including a characteristic (e.g., the characteristic X) peculiar to the type of abnormality is stored in a predetermined storage area in advance.

Abnormality Determination

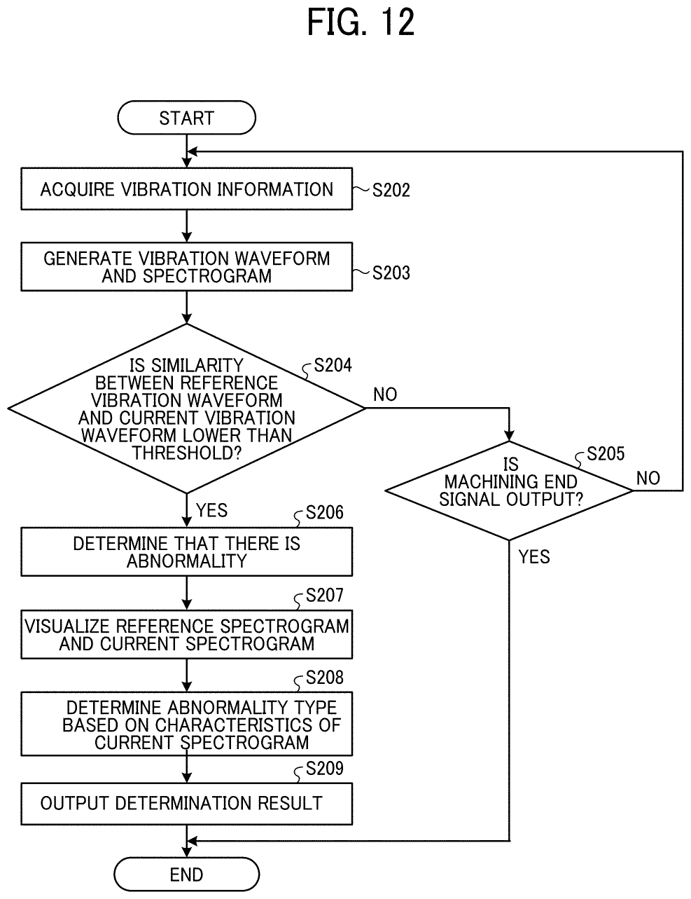

FIG. 12 is a flowchart illustrating an example of the flow of the abnormality determination in S201 according to the present embodiment. After the reference data is acquired as described above, the vibration information acquisition unit 111 acquires vibration information from the accelerometer 27 (S202). The vibration waveform generation unit 121 generates a vibration waveform based on the vibration information, and the spectrogram generation unit 122 generates a spectrogram based on the vibration waveform (S203). After that, the abnormality determination unit 131 compares the reference vibration waveform 201 acquired by the reference data acquisition process with the current vibration waveform 211, and determines whether or not the similarity therebetween is lower than a threshold (S204). The determination in S204 may be performed by comparing not only the vibration waveforms but also the spectrograms.

In response to a determination that the similarity between the reference vibration waveform 201 and the current vibration waveform 211 is not lower than the threshold, that is, the similarity is high, (S204: No), the determination unit 103 determines whether or not the pressing machine 11 has output a machining end signal to end the pressing process being executed (S205). In response to a determination that the machining end signal has been output (S205: Yes), the diagnostic apparatus 12 ends the abnormality determination in S201. In response to a determination that the machining end signal has not been output (S205: No), the diagnostic apparatus 12 again executes the processes after S202.

In S204, in response to a determination that the similarity between the reference vibration waveform 201 and the current vibration waveform 211 is lower than the threshold, that is, similarity is low, (S204: Yes), the abnormality determination unit 131 determines that there is an abnormality (S206). In S207, the spectrogram output unit 141 visualizes (for example, displays on the display 68) the reference spectrogram 202 and the current spectrogram 212. The abnormality type determination unit 132 determines the type of abnormality based on the characteristic (e.g., the characteristic X) of the current spectrogram 212 corresponding to the predetermined timings, such as the contact time A and the penetration time B (S208). Then, the determination result output unit 142 outputs the determination result by the abnormality determination unit 131 and the determination result by the abnormality type determination unit 132 in a predetermined output manner (S209). Examples of the predetermined output manner include displaying on a display and outputting of an alert sound.

In a configuration in which at least one of the functional units (the acquisition unit 101 to the output unit 104) of the diagnostic apparatus 12 according to the above-described embodiment is implemented by execution of a computer program, the program is incorporated in the ROM 62 or the like in advance. Alternatively, the computer program executed in the diagnostic apparatus 12 according the above-described embodiment can be provided as a file being in an installable format or an executable format and stored in a computer-readable recording medium, such as a compact disc read only memory (CD-ROM), a flexible disk (FD), a compact disc recordable (CD-R), and a digital versatile disk (DVD). Further, the computer program executed in the diagnostic apparatus 12 according the above-described embodiment can be stored in a computer connected to a network such as the Internet, to be downloaded via the network. Further, the computer program executed in the in the diagnostic apparatus 12 according the above-described embodiment can be provided or distributed via a network such as the Internet. A program to be executed by the diagnostic apparatus 12 according to the above-described embodiment has module structure including at least one of the above-described functional units. Regarding the actual hardware related to the program, the CPU 61 reads and executes the program from the memory as described above (e.g., the ROM 62 or the auxiliary memory 66) to load the program onto the main memory (e.g., the RAM 63) to implement the above-described functional units.

According to the above-described embodiment, a method for diagnosing a state of a pressing machine includes generating a vibration waveform indicating changes with elapse of time in a vibration of the pressing machine configured to perform a pressing process in which a tool is pressed against a material to deform the material; generating a spectrogram based on the vibration waveform; and determining an abnormality type of the pressing machine based on a characteristic of the spectrogram corresponding to the vibration of the pressing machine generated at a predetermined timing during the pressing process.

The above-described embodiment has an effect of improving the determination accuracy of the type of abnormality occurring in the pressing machine 11.

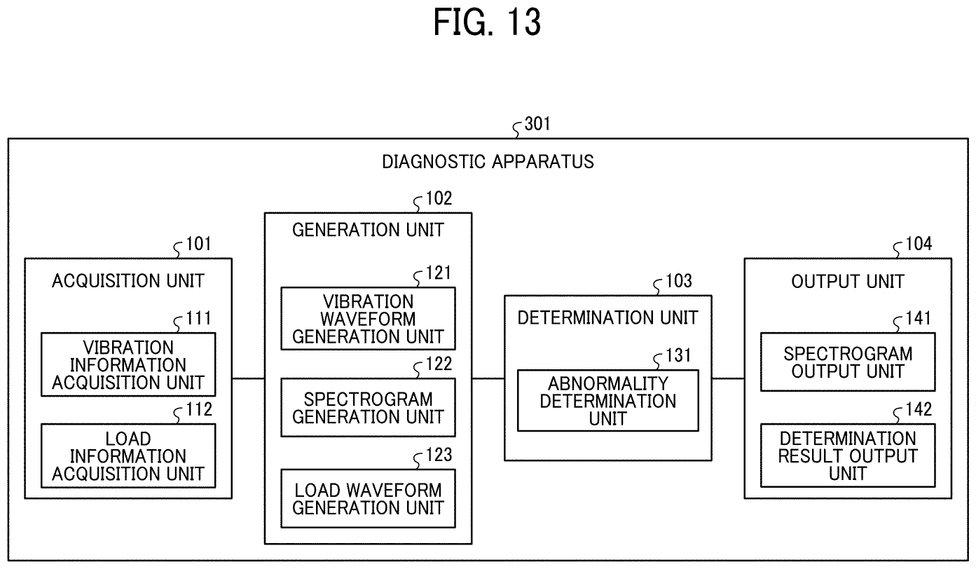

A description is given below of a modified example of the above-described embodiment, with reference to FIG. 13. In the description below, the same reference numerals will be given to elements that exhibit the same or similar effects as those of the above-described embodiments, and redundant description will be omitted.

FIG. 13 is a block diagram illustrating an example of the functional configuration of a diagnostic apparatus 301 according to the modified example. The diagnostic apparatus 301 according to the modified example is different from the diagnostic apparatus 12 according to the above-described embodiment in not including the abnormality type determination unit 132.

The diagnostic apparatus 301 according to the modified example illustrated in FIG. 13 does not include a functional unit that automatically determines the type of abnormality depending on whether or not the spectrogram 212 generated by the spectrogram generation unit 122 includes a predetermined characteristic (e.g., the characteristic X). The spectrogram output unit 141 visualizes the spectrogram 212 to be diagnosed. Therefore, the user can determine the type of abnormality viewing the visualized spectrogram 212. The spectrogram output unit 141 may visualize, for example, only the spectrogram 212 corresponding to the vibration waveform 211 determined as having an abnormality by the abnormality determination unit 131.

Even with such a modified example, the type of abnormality can be determined by a user who has knowledge of the characteristics appearing in the spectrogram at the time of abnormality. This configuration can reduce the calculation load on the diagnostic apparatus 12 and the storage capacity.

The present disclosure is not limited to the above-described embodiment and modifications thereof, and elements of the above-described embodiment and modifications include elements easily conceivable by those skilled in the art and elements substantially same as the above-described elements, that is, elements of a so-called equivalent scope. In addition, omissions, replacements, changes, and combinations of elements can be possible without departing from the gist of the above-described embodiment or modification.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

1. A diagnostic apparatus for diagnosing a state of a pressing machine, the diagnostic apparatus comprising circuitry configured to:
generate a spectrogram based on a vibration waveform indicating changes with elapse of time in a vibration of the pressing machine, the pressing machine being configured to perform a pressing process in which a tool is pressed against a material to deform the material; and
determine an abnormality type of the pressing machine based on a characteristic of the spectrogram corresponding to the vibration of the pressing machine generated at a predetermined timing during the pressing process.

2. The diagnostic apparatus according to claim 1,
wherein the tool is a punching tool and the pressing process is shearing, and
wherein the predetermined timing includes a contact time at which the punching tool comes into contact with the material during the shearing and a penetration time at which the punching tool penetrates the material during the shearing.

3. The diagnostic apparatus according to claim 2,
wherein the abnormality type includes wear of the punching tool.

4. The diagnostic apparatus according to claim 2,
wherein the circuitry is configured to identify the contact time and the penetration time based on a change with elapse of time of a load applied to the punching tool.

5. The diagnostic apparatus according to claim 1,
wherein the circuitry is configured to determine presence or absence of an abnormality in the pressing machine based on a characteristic of the vibration waveform.

6. A diagnostic apparatus for diagnosing a state of a pressing machine, the diagnostic apparatus comprising circuitry configured to:
generate a spectrogram based on a vibration waveform indicating changes with elapse of time in a vibration of the pressing machine configured to perform a pressing process in which a tool is pressed against a material to deform the material; and
visualize the spectrogram corresponding to the vibration of the pressing machine generated at a predetermined timing during the pressing process.

7. A non-transitory recording medium storing a plurality of program codes which, when executed by one or more processors, causes the processors to perform a method for diagnosing a state of a pressing machine, the method comprising:
generating a spectrogram based on a vibration waveform indicating changes with elapse of time in a vibration of the pressing machine configured to perform a pressing process in which a tool is pressed against a material to deform the material; and
determining an abnormality type of the pressing machine based on a characteristic of the spectrogram corresponding to the vibration of the pressing machine generated at a predetermined timing during the pressing process.
